(19) United States
(12) Patent Application Publication
(10) Pub. No.: US 2026/0304148 A1
(43) Pub. Date: Oct. 1, 2026

(54) AGENTIC ARTIFICIAL INTELLIGENCE FOR RAN INTELLIGENT CONTROLLER

(71) Applicant: RAKUTEN MOBILE, INC., Tokyo (JP)

(72) Inventors: Saurabh VERMA, Tokyo (JP); Masahiko NANRI, Tokyo (JP)

(73) Assignee: RAKUTEN MOBILE, INC., Tokyo (JP)

(21) Appl. No.: 19/095,153

(22) Filed: Mar. 31, 2025

(51) Int. Cl. H04W 24/02; H04L 41/0894

(52) U.S. Cl. CPC H04W 24/02; H04L 41/0894

(57) ABSTRACT

Example embodiments of the present disclosure relate to agentic artificial intelligence in RAN Intelligent Controller. The system may include a first artificial intelligence (AI) agent; a data fabric layer; and an AI inferencing layer, wherein the AI inferencing layer is configured to: receive, from the data fabric layer, at least one data related to a Radio Access Network (RAN); generate, based on the at least one data, at least one inference of the RAN; and deploy, based on the at least one inference, the first AI agent in the RAN.

### TECHNICAL FIELD

The present disclosure relates to agentic artificial intelligence (AI) for RAN intelligent controller (RIC).

### BACKGROUND

The information disclosed in this background section is only for the enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronthaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

### SUMMARY

In the related art, although the RIC may provide abstraction in terms of development of vendor agnostic solutions using the abovementioned xApp's and rApp's at Near-RT RIC 110 and Non-RT RIC 120 respectively, they introduce challenges to manage and coordinate these multi-vendor solutions through xApp's and rApp's. For example, it may be difficult to manage decision making via xApp's and rApp's, which would typically require a large amount of network information, while maintaining effective functionality and avoiding mutual conflict between vendors. While Artificial Intelligence (AI) solutions may be introduced in the related art, they may not provide an effective solution which can both create inferences at the higher network wide level as well as at the local level for functional execution.

Accordingly, there is a need to introduce a framework which can provide AI inferencing in an independent and autonomous manner to support operation of RIC functionalities.

Example embodiments of the present disclosure may provide a system including a first artificial intelligence (AI) agent; a data fabric layer; and an AI inferencing layer, wherein the AI inferencing layer is configured to: receive, from the data fabric layer, at least one data related to a Radio Access Network (RAN); generate, based on the at least one data, at least one inference of the RAN; and deploy, based on the at least one inference, the first AI agent in the RAN.

Based on the above example embodiments, AI agents with the framework including the inference layer may allow for inferencing as well as the required action at the places the agents are deployed to (e.g., to coordinate xApp and rApp for their execution to apply specific intent on network and its enforcement).

Accordingly, example embodiments may provide the capability of having network wide inferencing, utilizing a data fabric that provides access to comprehensive data from various data sources across the network (e.g., network specific internal data, external data sources from customer engagements, other administrative functionalities, etc.), deploying the required Agentic AI models on the RIC platform for inferencing at a deeper level, thereby creating a closed loop for required action for the network level and local level. Thus, xApp and rApp implementation may be improved in the RIC.

According to example embodiments, a method may be provided, the method including: receiving, by an Artificial Intelligence (AI) inferencing layer from a data fabric layer, at least one data related to a Radio Access Network (RAN); generating, by the AI inferencing layer based on the at least one data, at least one inference of the RAN; and deploying, by the AI inferencing layer based on the at least one inference, a first AI agent in the RAN.

According to example embodiments, a non-transitory computer-readable recording medium having recorded thereon instructions executable to perform a method may be provided, the method including: receiving, by an Artificial Intelligence (AI) inferencing layer from a data fabric layer, at least one data related to a Radio Access Network (RAN); generating, by the AI inferencing layer based on the at least one data, at least one inference of the RAN; and deploying, by the AI inferencing layer based on the at least one inference, a first AI agent in the RAN.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example O-RAN architecture according to the related art, in which one or more example embodiments may be applied;

FIG. 2 illustrates an example O-RAN architecture with respect to the RIC according to the related art, in which one or more example embodiments may be applied;

FIG. 3 illustrates an example O-RAN architecture implementing agentic AI according to one or more example embodiments;

FIG. 4 illustrates a diagram of the closed loop inferencing approach according to one or more example embodiments;

FIG. 5 illustrates a flowchart diagram between rApp, xApp, and a deployed agentic AI according to one or more example embodiments;

FIG. 6 illustrates a flowchart diagram for agentic AI's deployed in non-RT RIC and near-RT RIC according to one more example embodiments;

FIG. 7 illustrates a block diagram of an example method implemented by a inferencing layer for deploying an agentic AI, according to one or more example embodiments;

FIG. 8 illustrates a block diagram of an example device for implementing one or more example embodiments; and

FIG. 9 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

According to example embodiments, AI inferencing may be provided in an isolated, independent and autonomous framework to provide necessary support from an AI point of view to RIC specific functionalities.

The AI inferencing framework according to example embodiments may provide a unified network wide AI inferencing layer, which applies AI models using comprehensive databases available to be accessed through a data fabric layer, which connects multiple data sources across the network for pertinent and persistent access as a single point of access, wherever the data is required for AI inferencing models.

The AI inferencing layer according to example embodiments may have network wide inferencing, and connect with a library of various AI agents that need to be deployed at RIC specific platforms, such as the Non-Real Time (non-RT) RIC and Near Real time (near-RT) RIC. Those AI Agents (agentic AI) may be from a multi-vendor solution, and may provide AI specific support based on the need in the RIC.

The agentic AI may work for inferencing as well for required action at the places they are deployed to, i.e. they help to coordinate the xApp and rApp for their execution to apply specific intent on network and its enforcement.

According to example embodiments, a system may be provided including a first artificial intelligence (AI) agent; a data fabric layer; and an AI inferencing layer, wherein the AI inferencing layer is configured to: receive, from the data fabric layer, at least one data related to a Radio Access Network (RAN); generate, based on the at least one data, at least one inference of the RAN; and deploy, based on the at least one inference, the first AI agent in the RAN.

Based on the above example embodiments, AI agents with the framework including the inference layer may allow for inferencing as well as the required action at the places the agents are deployed to (e.g., to coordinate xApp and rApp for their execution to apply specific intent on network and its enforcement).

Accordingly, example embodiments may provide the capability of having network wide inferencing, utilizing a data fabric that provides access to comprehensive data from various data sources across the network (e.g., network specific internal data, external data sources from customer engagements, other administrative functionalities, etc.), deploying the required Agentic AI models on the RIC platform for inferencing at a deeper level, thereby creating a closed loop for required action for the network level and local level. Thus, xApp and rApp implementation may be improved in the RIC.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

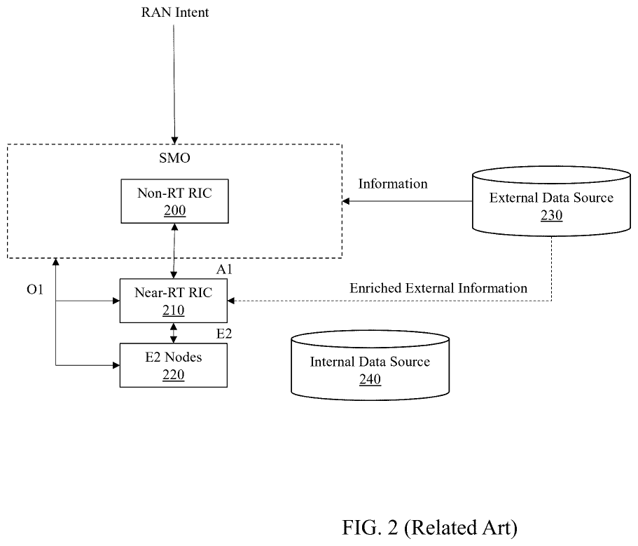

FIG. 2 illustrates an example O-RAN architecture with respect to the RIC according to the related art, in which one or more example embodiments may be applied.

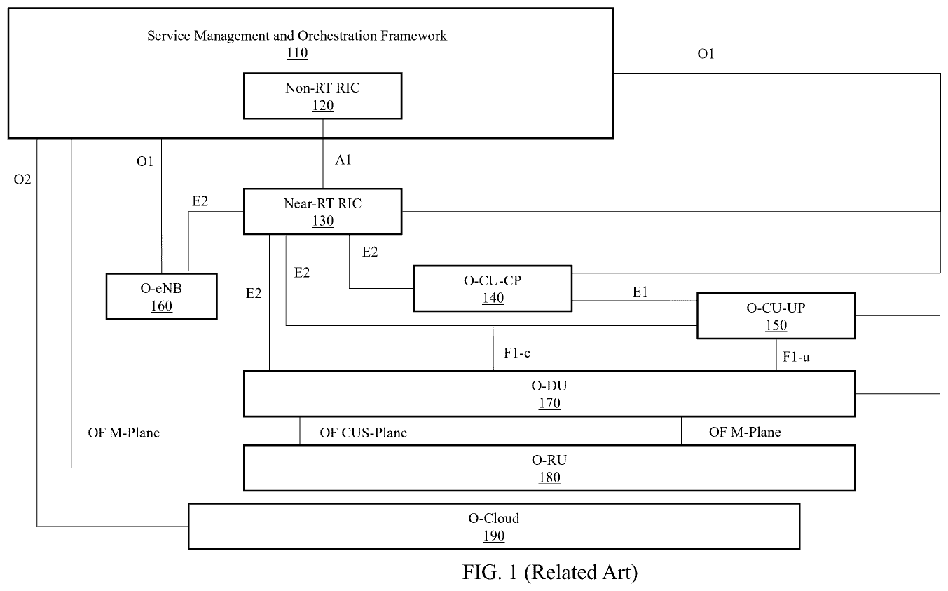

The non-RT RIC 200 and near-RT RIC 210 may be provided. Non-RT RIC 200 is provided in an SMO framework (see, for example, the O-RAN architecture illustrated and described with reference to FIG. 1 above) and may communicate with the near-RT RCI over an A1 interface. The SMO may receive the intent from the RAN, and interpret the RAN's intent to influence/manage network policies accordingly. The near-RT RIC 210 may communicate with E2 Nodes 220 over the E2 interface. The SMO (the Non-RT RIC 200), the Near-RT RIC 210, and E2 Nodes 220 may all be connected via the O1 interface.

For example, E2 nodes 220 may implement the DU and CU as gNB, and provide gNB function exposure to the near-RT RIC 210 and receive gNB function subscriptions from near-RT RIC 210 via the E2 interface. Meanwhile, the near-RT RIC 210 may provide policy type exposure through xApp's to the non-RT RIC 200, whereas near-RT RIC 210 may receive policy creation and updates from the non-RT 200 via rApp's.

An External Data Source 230 and Internal Data Source 240 for the RAN may be provided. The External data Source 230 may provide information to the SMO, and enriched external information to Near-RT RIC 210.

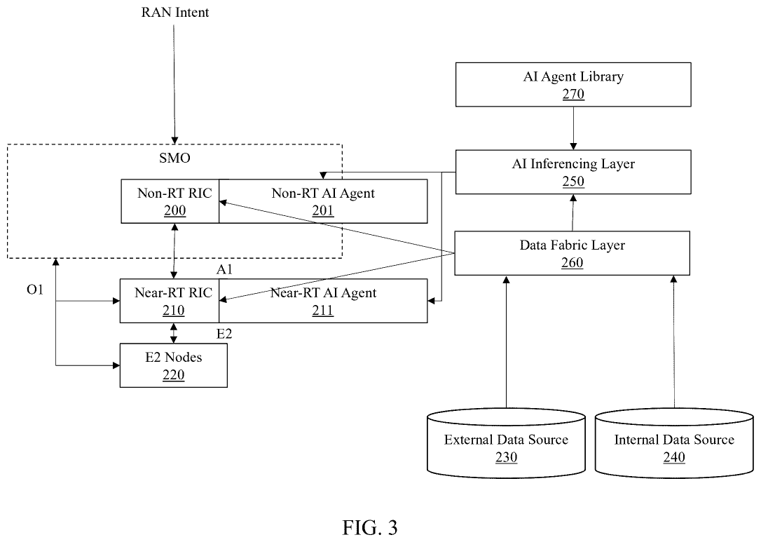

FIG. 3 illustrates an example O-RAN architecture implementing agentic AI according to one or more example embodiments. FIG. 3 introduces a non-RT AI agent 201, a near-RT AI agent 211, an AI inferencing layer 250, data fabric layer 260, and AI agent library 270, relative to FIG. 2.

Non-RT AI agent 201 and near-RT AI agent 211 are deployed in the Non-RT RIC 200 and near-RT RIC 210 respectively. The AI agents may be deployed by AI inferencing layer 250, based on an AI agent selected from AI agent library 270 (e.g., based on an inference made at the network-wide level by AI inferencing layer 250). Non-RT AI agent 201 and near-RT AI agent 211 may make inferences (via AI inferencing layer 250) based on actions and specific context on their respective deployed platforms in the RIC.

AI inferencing layer 250 is a unified AI inferencing layer for network level inferencing, and AI agent specific orchestration and deployments as required. As mentioned above, this primarily provides inferences via AI models for network-level inferencing, however, Non-RT AI agents 201 and near-RT AI agents 211 may utilize AI inferencing layer 250 to make local level inferences, as required.

Data fabric layer 260 may provide unified access to internal and external data where it is required, for example from external data source 230 and internal data source 240, which were previously separate data sources in FIG. 2. Data fabric layer 260 may provide this data to AI inferencing layer 250, or to the Non-RT RIC 200 and Near-RT RIC 210 platforms directly. The data sources used by data fabric layer 260 may be specific to O-RAN, depending on the specific implementation.

As mentioned above, AI agent library 270 may provide a library of AI agents which can be deployed. In particular, this library of AI agents may be vendor agnostic depending on the specific implementation.

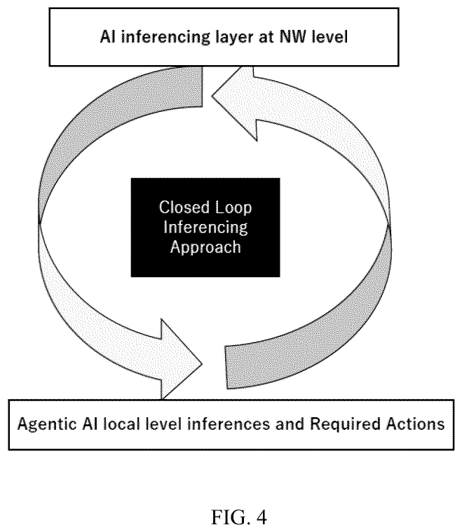

FIG. 4 illustrates a diagram of the closed loop inferencing approach according to one or more example embodiments.

At the top, AI inferencing layer 250 may make inferences at the network-wide level. This may cause agentic AI's to be deployed based on the respective RIC platforms, and perform the required actions accordingly at the local level. This in turn may cause changes in the network, along with changes in network intent, for example. Accordingly, the feedback may be provided back to the AI inferencing layer 250, such that AI inferencing layer 250 may make more inferences at the network-wide level. Accordingly, a closed loop inferencing approach may be achieved.

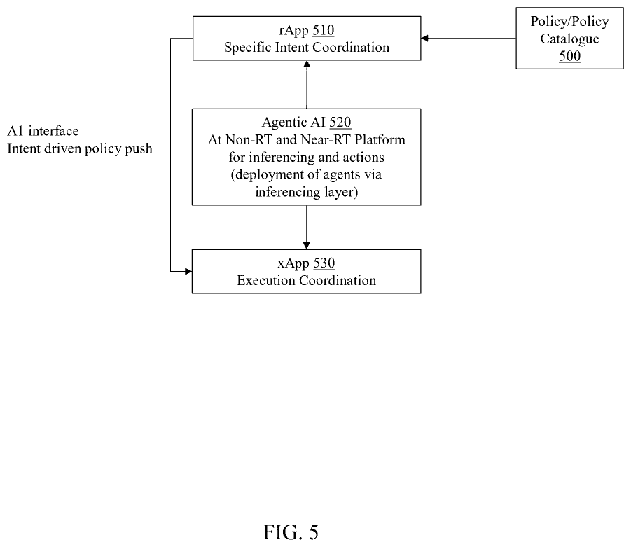

FIG. 5 illustrates a flowchart diagram between rApp, xApp, and a deployed agentic AI according to one or more example embodiments.

Policy/Policy Catalogue 500 may be provided. For example a policy may be selected from a policy catalogue. rApp's 510, which are deployed in the non-RT RIC, may provide specific intent coordination, based on receiving an instruction from Agentic AI 520 deployed in the non-RT RIC platform based on an inference. For example, an intent based on an inference from agentic AI 520 may translate/correspond to a policy/policy catalogue 500 being selected. rApp 510 may push the policy to xApp 530, via the A1 interface, as an intent driven policy push. xApp 530 may accordingly execute actions, which may also be based on inferences via the inferencing layer by agentic AI 520.

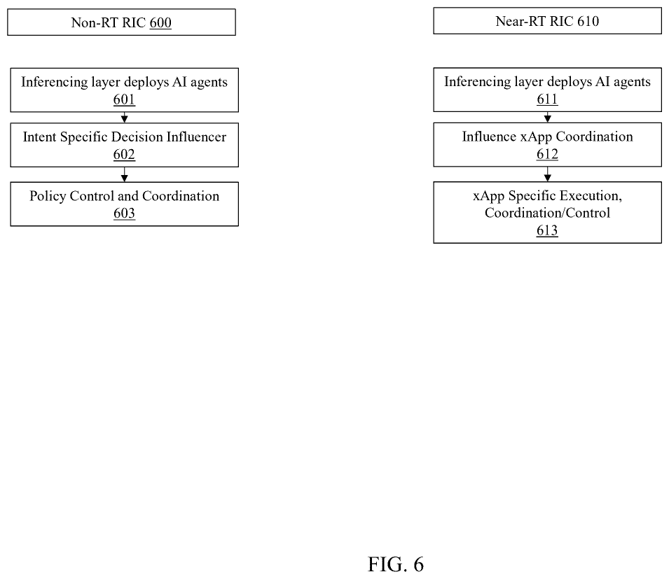

FIG. 6 illustrates a flowchart diagram for agentic AI's deployed in non-RT RIC 600 and near-RT RIC 610 according to one more example embodiments.

Referring firstly to the non-RT RIC 600, the inferencing layer may firstly deploy AI agents at 601 in non-RT RIC 600. At 602, intent specific decisions may be influenced by the deployed AI agent. Policy control (e.g., policy selection) and coordination may be performed thereafter based on the influenced intent at 603. This may be, for example, based on further inferences made at the local level by the agentic AI deployed at the non-RT RIC 600.

For the near-RT RIC 610, the inferencing layer may similarly firstly deploy AI agents at 611 at near-RT RIC 610. At 612, the deployed AI agent may influence xApp coordination/operation. At 613, the xApp may make the specific execution based on 612. This may be, for example, based on further inferences made at the local level by the agentic AI deployed at the near-RT RIC 610.

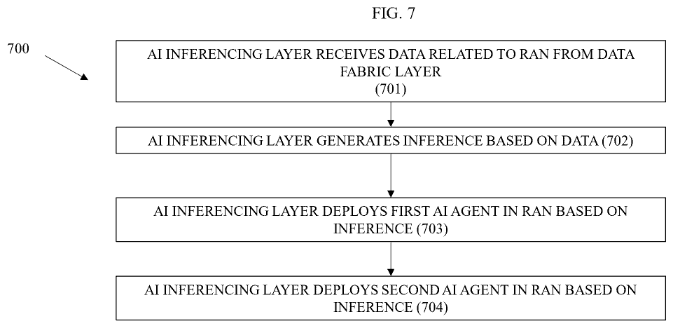

FIG. 7 illustrates a block diagram of an example method 700 implemented by a inferencing layer for deploying an agentic AI, according to one or more example embodiments;

At operation S701, an AI inferencing layer may receive the data related to the RAN from the data fabric layer.

At operation S702, an AI inferencing layer may generate an inference based on the data received in operation S701.

At operation S703, the AI inferencing layer may deploy a first AI agent in the RAN based on the inference based on the inference in operation S702. According to embodiments, this may be deployed in the near RT RIC of the RAN, and may be configured to generate local inferences using the AI inferencing layer, and manage xAPP's in the near-RT RIC based on the local inference.

At operation S704, the AI inferencing layer may deploy a second AI agent in the RAN based on the inference in operation S702. According to embodiments, this may be deployed in the non-RT RIC of the RAN, and may be configured to generate a local inference using the AI inferencing layer, and manage rApp's in the non-RT RIC based on the local inference. According to embodiments, this local inference may be generated based on an intent, and the rApp's may be configured to manage one or more policies in the RAN.

It should be appreciated that the AI inferencing layer may interface with a data fabric layer (comprising an internal data source of the RAN and an external data source of the RAN). Further, the first and second AI agents may be selected from an agentic AI library.

Based on the above example embodiments, AI agents with the framework including the inference layer may allow for inferencing as well as the required action at the places the agents are deployed to (e.g., to coordinate xApp and rApp for their execution to apply specific intent on network and its enforcement).

Accordingly, example embodiments may provide the capability of having network wide inferencing, utilizing a data fabric that provides access to comprehensive data from various data sources across the network (e.g., network specific internal data, external data sources from customer engagements, other administrative functionalities, etc.), deploying the required Agentic AI models on the RIC platform for inferencing at a deeper level, thereby creating a closed loop for required action for the network level and local level. Thus, xApp and rApp implementation may be improved in the RIC.

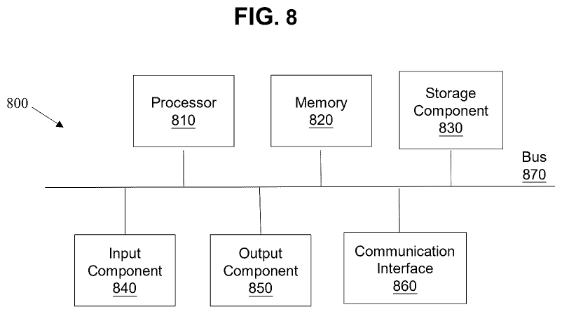

FIG. 8 illustrates a block diagram of an example device 800 for implementing one or more example embodiments. As shown in FIG. 8, the device 800 includes processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single core processor, or a combination of one or more multi-core processors and/or one or more single core processors, a distributed processing system, or the like. The processor 810 may be a Central Processing Unit (CPU), a graphics processing unit (GPU), an accelerated processing unit (APU), an application-specific integrated circuit (ASIC), or another type of processing component.

Memory 820 includes a non-transitory computer readable medium. Memory 820 includes a random-access memory (RAM), a read only memory (ROM), and/or another type of dynamic or static storage device (e.g., a flash memory, a magnetic memory, and/or an optical memory) that stores information and/or instructions for use by processor 810. The memory 820 comprises machine-readable instructions which are executable by the processor 810. These machine-readable instructions when executed by the processor 810 cause the processor 810 to perform one or more method steps of an embodiment described above.

Storage component 830 stores information and/or software related to the operation and use of the device 800. For example, storage component 830 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a global positioning system (GPS), an accelerometer, a gyroscope, and/or an actuator).

Output component 850 is configured to provide output information from the device 800. For example, the output component 850 may be, but not limited to, a display, a speaker, an instruction device to an external device, and/or one or more light-emitting diodes (LEDs).

Communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800. Further, one or more method steps described in any of the embodiments may be performed utilizing a plurality of devices 800 in communication with one another.

Example embodiments of the present disclosure may be implemented in any suitable type of environment. In the following, an example environment (in which the example embodiments may be implemented) is described.

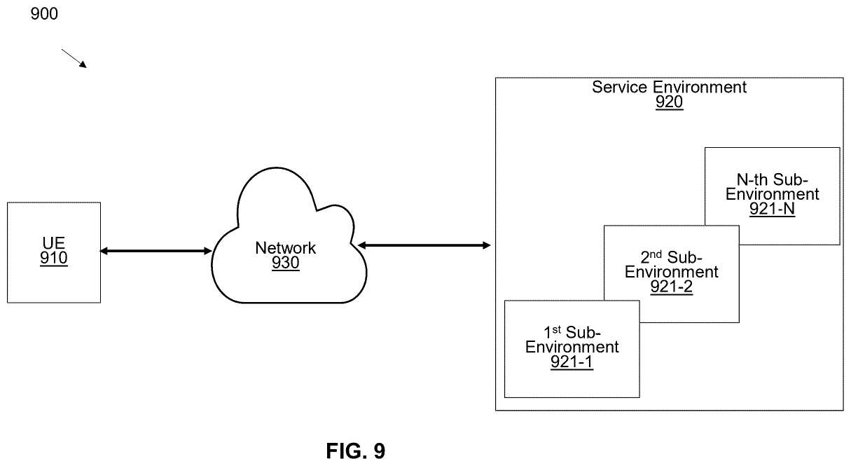

FIG. 9 illustrates a block diagram of an example environment 900 for implementing in which systems and/or method, described herein, may be implemented. The implementation environment 900 includes a UE (User equipment) 910, a service environment 920, and a network 930. The service environment 920 include one or more sub-environments 921. To illustrate this, FIG. 9 shows, for convenience, examples of a 1st sub-environment 921-1, a 2nd sub-environment 921-2, and an N-th sub-environment 921-N (where N is any natural number).

The UE 910 is connected to the network 930, and the network 930 is connected to the service environment 920. The connections may be wired, wireless, or a combination of both wired and wireless. The UE 910 and the service environment 920 are connected via the network 930.

The UE 910 is a device that communicates with the service environment 920. The UE 910 receives information from the service environment 920 and/or sends information to the service environment 920. Also, the UE 910 may generate and/or store information to be transmitted, as necessary. Also, the UE 910 may store and/or process information that is received, as necessary.

The example FIG. 9 refers to the “UE”. However, it should be understood by those skilled in the art that general terms such as “user device,” “terminal,” “terminal device,” “communication device,” and “communication terminal” can be used interchangeably with the term “UE.”

For example, the UE 910 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 920 is an environment that communicates with the UE 910 to provide one or more services. The service environment 920 receives information from the UE 910 and/or sends information to the UE 910. Also, the service environment 920 may generate and/or store information to be transmitted, as necessary. Also, the service environment 920 may store and/or process information that is received, as necessary. For example, the service environment 920 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 9 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 920 is not specifically limited and can be adjusted according to the embodiments. For example, the services may include a service that provides information to the UE 910, a service that stores information from the UE 910, or a service that performs processing based on information from the UE 910 and returns the results of the processing.

In an embodiment, the Service Environments 920 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 920 includes one or more devices, such as servers and network devices, which provide services or perform processes. The placement of these devices within the service environment 920 can be determined as appropriate. Additionally, if the service environment 920 includes one or more sub-environments 921, the placement of devices can be determined based on predetermined policies for each sub-environment 921. For example, devices related to the first service may be placed in the 1st sub-environment 921-1, and devices related to the second service may be placed in the 2nd sub-environment 921-2. In another example, devices expected to have a higher load than a predetermined threshold may be placed in the 1st sub-environment 921-1, while devices expected to have a lower load than the predetermined threshold may be placed in the 2nd sub-environment 921-2. In this way, specific devices can be placed in specific sub-environments 921. Conversely, each sub-environment 921 can be specialized for a particular purpose.

In an embodiment, all processes executed in a single service may run within a single service environment, or in multiple service environments. Multiple processes executed in a single service could be provided by different service environments.

The network 930 is a network that exchanges information between the UE 910 and the service environment 920. The network 930 includes one or more wired and/or wireless networks.

For example, the network 930 may include a cellular network (e.g., a fifth generation (9G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 930 can be a part of a network. For example, in a 9G network that includes a RAN, a transport network, and a core network, the network 930 can be at least one of the RAN, the transport network, or the core network. For example, the service environment 920 could be in the core network, in which case the network 930 could correspond to a network that is a combination of a RAN and a transport network and is part of the 9G network.

The number and arrangement of devices and networks shown in FIG. 9 are provided as an example. It should be understood that any changes that may be implemented by those skilled in the art, such as the addition or rearrangement of well-known devices or networks at the time of implementation, are included in this disclosure.

### VARIOUS ASPECTS OF EMBODIMENTS

It is contemplated that the example embodiments described hereinabove with reference to FIG. 3 to FIG. 9 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system including: a first artificial intelligence (AI) agent; a data fabric layer; and an AI inferencing layer, wherein the AI inferencing layer is configured to: receive, from the data fabric layer, at least one data related to a Radio Access Network (RAN); generate, based on the at least one data, at least one inference of the RAN; and deploy, based on the at least one inference, the first AI agent in the RAN.
Item [2]: The system according to Item [1], further including: a second AI agent; wherein the first AI agent is deployed in a near-realtime (near-RT) RAN Intelligent Controller (RIC) of the RAN; wherein the AI inferencing layer is further configured to: deploy, based on the at least one inference, the second AI agent in the non-realtime (non-RT) RIC of the RAN.
Item [3]: The system according to Item [2], wherein the first AI agent is configured to: generate a local inference using the AI inferencing layer; and manage xApp's in the near-RT RIC based on the local inference.
Item [4]: The system according to Item [2], wherein the second AI agent is configured to: generate a local inference using the AI inferencing layer; and manage rApp's in the non-RT RIC based on the local inference.
Item [5]: The system according to Item [4], wherein the local inference is generated based on an intent, and wherein the rAPP's are configured to manage one or more policies in the RAN.
Item [6]: The system according to any one of Items [1]-[5], wherein the data fabric layer includes an internal data source of the RAN and an external data source of the RAN.
Item [7]: The system according to Item [2], further including: an agentic AI library, wherein the first AI agent and the second AI agent are selected from the agentic AI library.
Item [8]: A method including: receiving, by an Artificial Intelligence (AI) inferencing layer from a data fabric layer, at least one data related to a Radio Access Network (RAN); generating, by the AI inferencing layer based on the at least one data, at least one inference of the RAN; and deploying, by the AI inferencing layer based on the at least one inference, a first AI agent in the RAN.
Item [9]: The method according to Item [8], further including: deploying, by the AI inferencing layer based on the at least one inference, a second AI agent in the non-realtime (non-RT) RIC of the RAN, wherein the first AI agent is deployed in a near-realtime (near-RT) RAN Intelligent Controller (RIC) of the RAN;
Item [10]: The method according to Item [9], wherein the first AI agent is configured to: generate a local inference using the AI inferencing layer; and manage xApp's in the near-RT RIC based on the local inference.
Item [11]: The method according to any one of Items [9]-[10], wherein the second AI agent is configured to: generate a local inference using the AI inferencing layer; and manage rApp's in the non-RT RIC based on the local inference.
Item [12]: The method according to Item [11], wherein the local inference is generated based on an intent, and wherein the rAPP's are configured to manage one or more policies in the RAN.
Item [13]: The method according to any one of Items [8]-[12], wherein the data fabric layer includes an internal data source of the RAN and an external data source of the RAN.
Item [14]: The method according to Item [9], wherein the first AI agent and the second AI agent are selected from an agentic AI library.
Item [15]: A non-transitory computer-readable recording medium having recorded thereon instructions executable to perform a method including: receiving, by an Artificial Intelligence (AI) inferencing layer from a data fabric layer, at least one data related to a Radio Access Network (RAN); generating, by the AI inferencing layer based on the at least one data, at least one inference of the RAN; and deploying, by the AI inferencing layer based on the at least one inference, a first AI agent in the RAN.
Item [16]: The non-transitory computer-readable recording medium according to Item [15], the method further including: deploying, by the AI inferencing layer based on the at least one inference, a second AI agent in the non-realtime (non-RT) RIC of the RAN, wherein the first AI agent is deployed in a near-realtime (near-RT) RAN Intelligent Controller (RIC) of the RAN;
Item [17]: The non-transitory computer-readable recording medium according to Item [16], wherein the first AI agent is configured to: generate a local inference using the AI inferencing layer; and manage xApp's in the near-RT RIC based on the local inference.
Item [18]: The non-transitory computer-readable recording medium according to any one of Items [16]-[17], wherein the second AI agent is configured to: generate a local inference using the AI inferencing layer; and manage rApp's in the non-RT RIC based on the local inference.
Item [19]: The non-transitory computer-readable recording medium according to Item [18], wherein the local inference is generated based on an intent, and wherein the rAPP's are configured to manage one or more policies in the RAN.
Item [20]: The non-transitory computer-readable recording medium according to any one of Items [15]-[19], wherein the data fabric layer comprises an internal data source of the RAN and an external data source of the RAN.

It will be apparent that within the scope of the appended clauses, the present disclosures may be practiced otherwise than as specifically described herein.

What is claimed is:

1. A system comprising:
a first artificial intelligence (AI) agent;
a data fabric layer; and
an AI inferencing layer, wherein the AI inferencing layer is configured to:
receive, from the data fabric layer, at least one data related to a Radio Access Network (RAN);
generate, based on the at least one data, at least one inference of the RAN; and
deploy, based on the at least one inference, the first AI agent in the RAN.

2. The system as claimed in claim 1, further comprising:
a second AI agent;
wherein the first AI agent is deployed in a near-realtime (near-RT) RAN Intelligent Controller (RIC) of the RAN;
wherein the AI inferencing layer is further configured to:
deploy, based on the at least one inference, the second AI agent in the non-realtime (non-RT) RIC of the RAN.

3. The system as claimed in claim 2, wherein the first AI agent is configured to:
generate a local inference using the AI inferencing layer; and
manage xApp's in the near-RT RIC based on the local inference.

4. The system as claimed in claim 2, wherein the second AI agent is configured to:
generate a local inference using the AI inferencing layer; and
manage rApp's in the non-RT RIC based on the local inference.

5. The system as claimed in claim 4, wherein the local inference is generated based on an intent, and wherein the rAPP's are configured to manage one or more policies in the RAN.

6. The system as claimed in claim 1, wherein the data fabric layer comprises an internal data source of the RAN and an external data source of the RAN.

7. The system as claimed in claim 2, further comprising:
an agentic AI library, wherein the first AI agent and the second AI agent are selected from the agentic AI library.

8. A method comprising:
receiving, by an Artificial Intelligence (AI) inferencing layer from a data fabric layer, at least one data related to a Radio Access Network (RAN);
generating, by the AI inferencing layer based on the at least one data, at least one inference of the RAN; and
deploying, by the AI inferencing layer based on the at least one inference, a first AI agent in the RAN.

9. The method as claimed in claim 8, the method further comprising:
deploying, by the AI inferencing layer based on the at least one inference, a second AI agent in the non-realtime (non-RT) RIC of the RAN, wherein the first AI agent is deployed in a near-realtime (near-RT) RAN Intelligent Controller (RIC) of the RAN.

10. The method as claimed in claim 9, wherein the first AI agent is configured to:
generate a local inference using the AI inferencing layer; and
manage xApp's in the near-RT RIC based on the local inference.

11. The method as claimed in claim 9, wherein the second AI agent is configured to:
generate a local inference using the AI inferencing layer; and
manage rApp's in the non-RT RIC based on the local inference.

12. The method as claimed in claim 11, wherein the local inference is generated based on an intent, and wherein the rAPP's are configured to manage one or more policies in the RAN.

13. The method as claimed in claim 8, wherein the data fabric layer comprises an internal data source of the RAN and an external data source of the RAN.

14. The method as claimed in claim 9, wherein the first AI agent and the second AI agent are selected from an agentic AI library.

15. A non-transitory computer-readable recording medium having recorded thereon instructions executable to perform a method comprising:
receiving, by an Artificial Intelligence (AI) inferencing layer from a data fabric layer, at least one data related to a Radio Access Network (RAN);
generating, by the AI inferencing layer based on the at least one data, at least one inference of the RAN; and
deploying, by the AI inferencing layer based on the at least one inference, a first AI agent in the RAN.

16. The non-transitory computer-readable recording medium as claimed in claim 15, the method further comprising:
deploying, by the AI inferencing layer based on the at least one inference, a second AI agent in the non-realtime (non-RT) RIC of the RAN, wherein the first AI agent is deployed in a near-realtime (near-RT) RAN Intelligent Controller (RIC) of the RAN.

17. The non-transitory computer-readable recording medium as claimed in claim 16, wherein the first AI agent is configured to:
generate a local inference using the AI inferencing layer; and
manage xApp's in the near-RT RIC based on the local inference.

18. The non-transitory computer-readable recording medium as claimed in claim 16, wherein the second AI agent is configured to:
generate a local inference using the AI inferencing layer; and
manage rApp's in the non-RT RIC based on the local inference.

19. The non-transitory computer-readable recording medium as claimed in claim 18, wherein the local inference is generated based on an intent, and wherein the rAPP's are configured to manage one or more policies in the RAN.

20. The non-transitory computer-readable recording medium as claimed in claim 15, wherein the data fabric layer comprises an internal data source of the RAN and an external data source of the RAN.
